(19) United States
(12) Patent Application Publication
(10) Pub. No.: US 2019/0359414 A1
(43) Pub. Date: Nov. 28, 2019

(54) LINER

(71) Applicant: Pratt Corrugated Holdings, Inc., Conyers, GA (US)

(72) Inventors: Greg Sollie, Sharpsburg, GA (US); Jamie Waltermire, Peachtree City, GA (US); Shifeng Chen, Newport News, VA (US)

(21) Appl. No.: 16/530,052

(22) Filed: Aug. 2, 2019

Related U.S. Application Data
(63) Continuation of application No. 15/988,550, filed on May 24, 2018.

(51) Int. Cl. B65D 81/38; B65D 5/60; B31B 50/74

(52) U.S. Cl. CPC B65D 81/3858; B31B 2120/402; B31B 50/74; B65D 5/60

(57) ABSTRACT

A packaging assembly comprising a box and a liner positioned in the box. The liner comprises a panel and a single piece of insulative material coupled to the panel. The liner comprises a fiber-based material. The liner defines a plurality of sub-portions. The liner defines a plurality of bend lines. Each bend line connects one sub-portion of the liner with another sub-portion of the liner. The single piece of insulative material and the panel together extend across at least two bend lines.

### CROSS-REFERENCE TO RELATED APPLICATIONS

This application is a continuation of U.S. application Ser. No. 15/988,550, filed May 24, 2018, which is hereby incorporated by reference herein in its entirety.

### TECHNICAL FIELD

This disclosure relates to packaging. More specifically, this disclosure relates to liners for packaging.

### BACKGROUND

Packaging can sometimes require insulation, although in various aspects, insulation may not be included. In various aspects, insulation packaging can be complex and require complicated manufacture and assembly.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

Disclosed is a packaging assembly comprising a box and a liner positioned in the box. The liner comprises a panel and a single piece of insulative material coupled to the panel. The liner comprises a fiber-based material. The liner defines a plurality of sub-portions. The liner defines a plurality of bend lines. Each bend line connects one sub-portion of the liner with another sub-portion of the liner. The single piece of insulative material and the panel together extend across at least two bend lines.

Also disclosed is a packaging assembly comprising a box and a liner. The box defines a front, a back, a first side, a second side and a bottom. The liner comprises a panel and a single piece of insulative material coupled to the panel. The panel comprises a fiber-based material. The liner defines a plurality of sub-portions. The plurality of sub-portions comprising a first sub-portion and a second sub-portion. The first sub-portion of the liner is adjacent to one of the front, the back, the first side or the second side of the box. The second sub-portion of the liner is adjacent to one of the front, the back, the first side or the second side of the box. The liner defines a plurality of bend lines. Each bend line connects one of the sub-portion of the liner with another sub-portion of the liner. The single piece of insulative material and the panel together extend across at least one bend line that is a vertical bend line

Also disclosed is a packaging assembly comprising a box and a liner. The box defines a front, a back, a first side, a second side and a bottom. The liner comprises a panel and a single piece of insulative material coupled to the panel. The panel comprises a fiber-based material. The liner defines a liner flap and a liner back. The liner back is adjacent to one of the front, the back, the first side or the second side of the box. The single piece of insulative material and panel extend across a bend line connecting the liner flap with the liner back.

Also disclosed is a method of assembling a packaging assembly comprising the steps of providing a box and a liner. The box defines a front, a back, a first side, a second side, and a bottom. The liner comprises a panel and a single piece of insulative material coupled to the panel. The panel comprises a fiber-based material. The liner defines a liner flap and a liner back. The liner back is adjacent to one of the front, the back, the first side or the second side of the box. The single piece of insulative material panel and the panel together extend across a bend line connecting the liner flap with the liner back. The method further comprising the steps of inserting the liner back within the box so that the liner back is adjacent to one of the front, the back, the first side or the second side of the box and folding the liner flap relative to the liner back.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a front perspective view of a liner in accord with one aspect of the current disclosure.

FIG. 2 is a bottom perspective view of the liner of FIG. 1.

FIG. 3 is a front perspective view of the liner of FIG. 1.

FIG. 4A is a close-up perspective view of a pleat of the liner of FIG. 1.

FIG. 4B is a close-up perspective view of the pleat of FIG. 4A expanded.

FIG. 5 is a close-up perspective view of the liner of FIG. 1 as being assembled into a box.

FIG. 6A is a front perspective view of the liner of FIG. 1 assembled into a box, thereby forming a packaging assembly.

FIG. 6B is a side perspective view of the packaging assembly of FIG. 6A.

FIG. 7 is a perspective view of the packaging assembly of FIG. 6A with a flap portion folded.

FIG. 8 is an exploded perspective view of a liner panel assembly in accord with one aspect of the current disclosure.

FIG. 9 is a front perspective view of the liner panel assembly of FIG. 8.

FIG. 10 is a front perspective view of a liner subassembly formed from the liner panel assembly of FIG. 9.

FIG. 11 is a front perspective view of a support in accord with one aspect of the current disclosure.

FIG. 12 is a front perspective view of a liner formed from the liner subassembly of FIG. 10 and the support of FIG. 11

FIG. 13 is a front perspective view of the liner of FIG. 12 in partial arrangement for insertion into a box.

FIG. 14 is a front perspective view of the liner of FIG. 12 in arrangement for insertion into a box.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a liner and associated methods, systems, devices, and various apparatus. The liner can include insulation in various implementations. It would be understood by one of skill in the art that the disclosed liner is described in but a few exemplary aspects among many. No particular terminology or description should be considered limiting on the disclosure or the scope of any claims issuing therefrom.

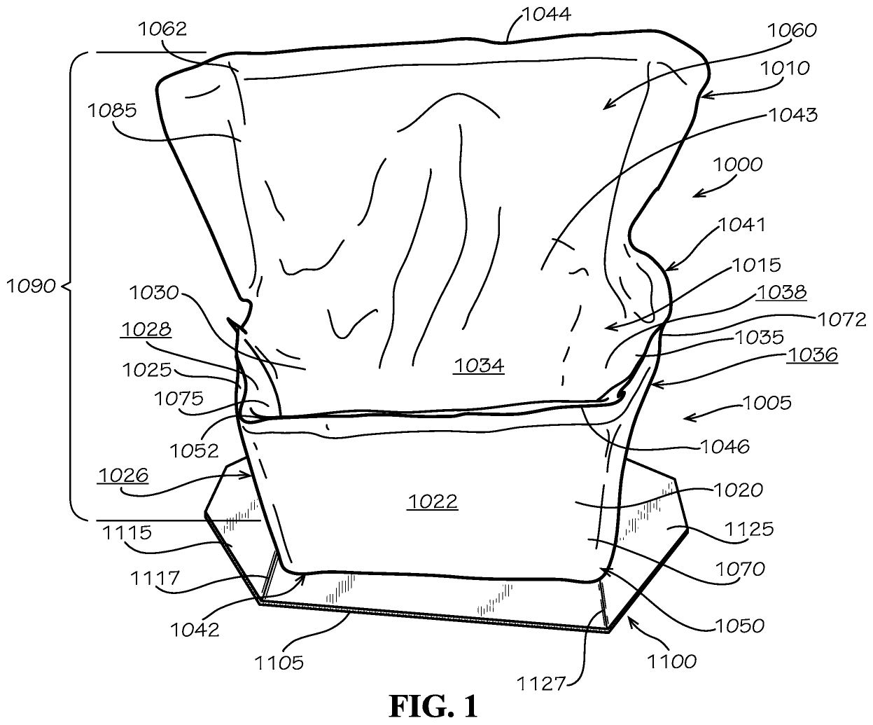

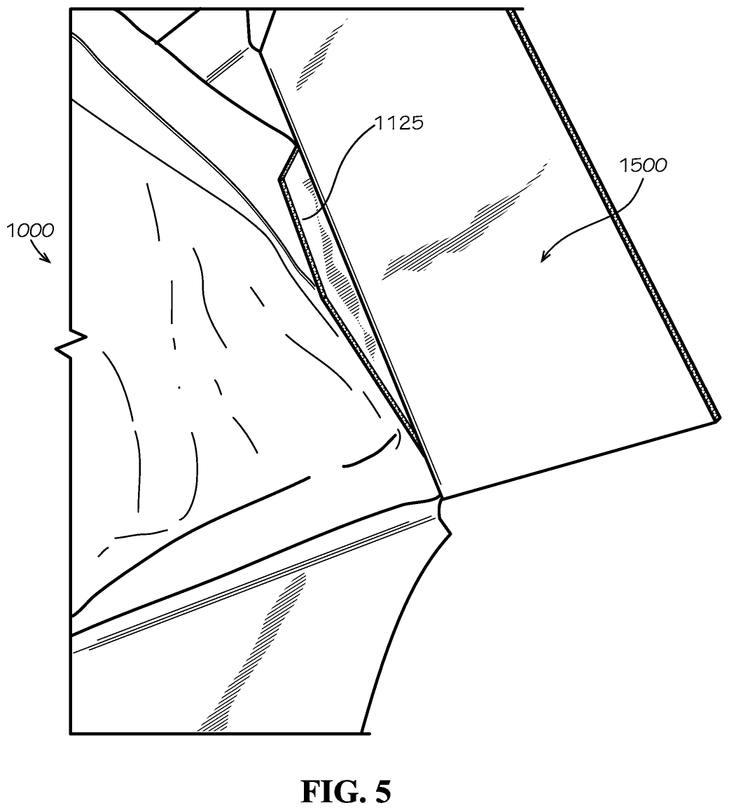

One embodiment of a liner 1000 is disclosed and described with reference to FIG. 1. The liner 1000 can broadly define a body portion 1005 and a flap portion 1010. In various aspects, the liner 1000 can be of various shapes. In various aspects, the shapes of the liner 1000 can be arranged or shaped to accommodate various packaging styles and shapes. In the current aspect, the body portion 1005 can be substantially block-shaped or box-shaped to accommodate box-shaped packaging. The body portion 1005 can define a cavity 1015. The body portion 1005 can comprise a front 1020, a side 1025, a back 1030, and another side 1035 that together can define the cavity 1015. The front 1020 can comprise an outer surface 1022 and an inner surface 1024 (shown in FIG. 6B). The back 1030 can comprise an outer surface 1032 (shown as part of the flap portion 1010 in FIG. 6B) and an inner surface 1034. The side 1025 can comprise an outer surface 1026 and an inner surface 1028. The side 1035 can comprise an outer surface 1036 and an inner surface 1038.

The body portion 1005 can define an upper end 1041 and a lower end 1042. The lower end 1042 of the body portion 1005 can comprise a bottom (not shown). In the current aspect, the bottom can be substantially similar in construction and materials as the front 1020, back 1030, and sides 1025,1035.

The flap portion 1010 can comprise a body connection end 1043 that can serve the connection of the flap portion 1010 to the body portion 1005. The flap portion 1010 can comprise a flap end 1044 that can serve as an end of the flap portion 1010.

The liner 1000 can comprise a skin material and a filler material. The skin material can be of various constructions, materials, shapes, and purposes, including but not limited to plastic films, paper materials, cloth, and like materials. In the current aspect, the skin material can be kraft paper. In various aspects, the filler material can be a variety of materials, including thermally insulative and/or protective materials. In the current aspect, the insulative material can be paper fill material. In various aspects, the insulative material can be loose fill insulation such as paper, cellulose, or various foam materials such as polystyrene. In various aspects, the insulative material can be open-cell or closed-cell foams. In various aspects, the insulative material can be a paper and fiber combination and can be in loose fill form or in batt form. In various aspects, the insulative material can be loose fill, batt, board, or other applications.

In the current aspect, the skin material can be joined at a seam such as seam 1046 seen at the upper end 1041 of the body portion. In certain aspects, the liner 1000 of the current disclosure can be formed of two pieces of kraft paper comprising an inner panel and an outer panel. In such aspects, the seam 1046 can continue along the flap portion 1010 to the flap end 1044 in various aspects. In various aspects, the liner 1000 can comprise three panels, comprising an inner panel and two outer panels. In the current aspect, the liner 1000 can comprise four panels. Two panels can be joined together to form a front half 1050 of the liner 1000 and two panels can be joined together to form a rear half 1060 of the liner 1000; the two halves can then be joined at a seam in the body portion 1005. In the current aspect, the liner 1000 can comprise an outer front panel 1070, and inner front panel 1075, an outer rear panel 1080 (shown in FIG. 6B) and an inner rear panel 1085. The various panels in the current aspect can be sheets of kraft paper. The front half 1050 can be joined using a seam 1052 or joint that can be joined around the perimeter of the panels 1070, 1075. Between the panels 1070,1075 can be captured an amount of insulative or filler material, as previously discussed. The rear half 1060 of the liner 1000 can be joined using a seam 1062 or joint to join the perimeter of panels 1080, 1085. Insulative material can similarly be captured within the rear half 1060. The front half 1050 and the rear half 1060 can be joined at a seam 1072 that can extend substantially along the body portion 1005. In the current aspect, the seam 1072 can join portions of the seam 1052 and the seam 1062 together.

The various panels can be joined at seams (such as seams 1046,1052,1062,1072) by adhesive, chemical joining, mechanical joints, welds such as sonic welding, sewing, or various other joint mechanisms known in the art. In various aspects, the seams can be joined using staples, key fit arrangements, interference, or co-forming. In various aspects, the joints or seams can be eliminated in favor of integrated construction, and various modifications to the arrangements of joints or seams can be utilized without departing from the scope of this disclosure. Additional numbers of panels or seams may be utilized to modify the structure of the liner 1000 within the scope of the current disclosure.

The front half 1050 and the rear half 1060 can be comprised within a liner subassembly 1090 that can form the portions of the liner 1000 previously described. The liner 1000 in the current aspect can be a liner assembly and can comprise a support 1100 connected to or abutting the bottom of the liner subassembly 1090. The support 1100 can be of varying constructions and can be designed to provide structure and support to the liner 1000 and as separate from the liner subassembly 1090, which can in some aspects be unstructured. In various aspects, the liner subassembly 1090 can comprise structures connected to or within the front half 1050 and/or the rear half 1060 to provide support. In the current aspect, the support 1100 can be connected to the bottom of the liner subassembly 1090 to provide structure and support that can be lacking.

The support 1100 can be connected to the bottom of the liner subassembly 1090 by adhesive or mechanical joints as described elsewhere in this disclosure. The support 1100 can be formed of corrugated cardboard material. In various aspects, the support 1100 can be formed of cardboard, paperboard, wood, plastic, or various other rigid or semi-rigid materials. In various aspects, the support 1100 can comprise a framework. In various aspects, the support 1100 can comprise mechanical joints or hinges.

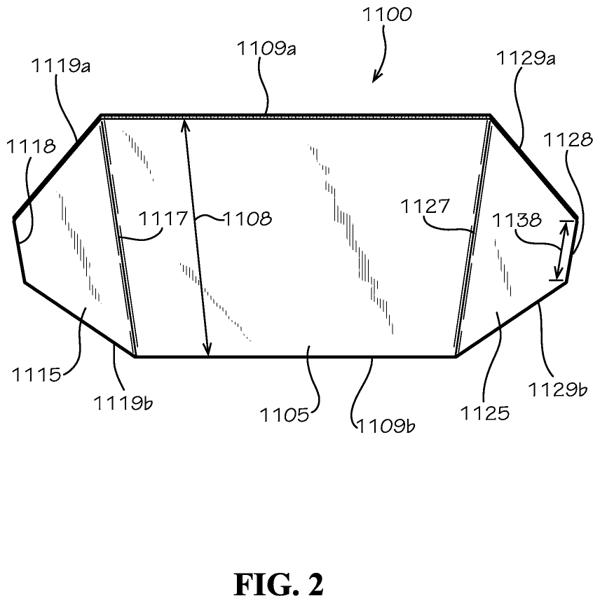

As seen with reference to FIGS. 1-2, the support 1100 can comprise a central body 1105, a first end portion 1115, and a second end portion 1125. The central body 1105 of the current aspect can be about rectangular in shape, and the end portions 1115,1125 can be about trapezoidal in shape and can taper from the central body 1105 outwards. The end portions 1115,1125 can be connected to the central body 1105 by bend lines 1117,1127, respectively. The bend lines 1117,1127 can be hinges, living hinges, perforations, score lines, or various other mechanical arrangements known to one of skill in the art in various aspects.

As seen with specific reference to FIG. 2, the central body 1105 can define parallel ends 1109a,b. Further, each end portion 1115,1125 can include tapered ends 1119a,b and 1129a,b, respectively. The tapered ends 1119a,b,1129a,b, can terminate into a nose end 1118, 1128. In the current aspect, tapered ends 1119a,b,1129a,b, can be arranged at about a 45° angle with respect to the ends 1109a,b. In various aspects, the tapered ends 1119a,b,1129a,b can be arranged at varying angles from as small as 30° to as large as 75°. In the current aspect, a length 1138 of the nose ends 1118,1128 can be about one-fourth of a width 1108 of the central body 1105. In various aspects, the length 1138 can be about one-third of the width 1108. In various aspects, the length 1138 can be about one-fifth of the width 1108. In various aspects, the length 1138 can be as little as one-sixth and as great as three-fourths of the width 1108. The taper defined by the tapered ends 1119a,b,1129a,b, can be beneficial in reducing resistance when assembling the liner 1000 into packaging.

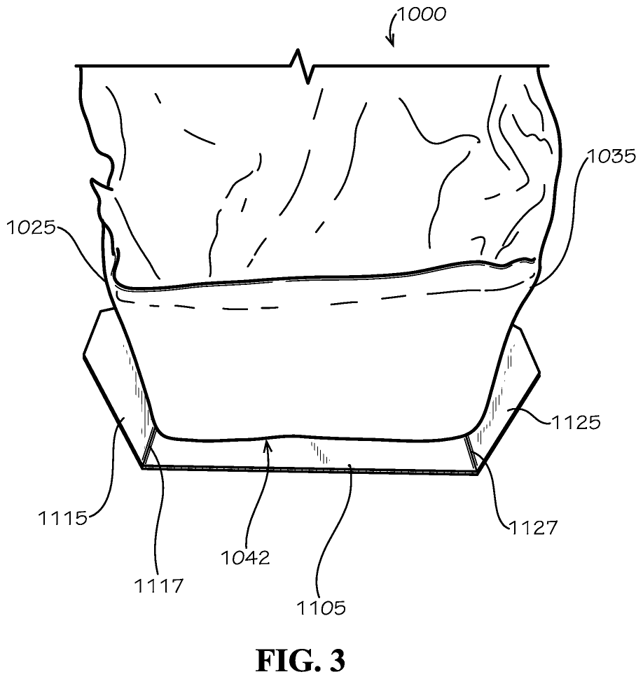

As seen with reference to FIG. 3, the end portions 1115,1125 can be bent or hinged with respect to the central body 1105 along bend lines 1117,1127. As the end portions 1115,1125 are bent, the end portions 1115,1125 can provide support for the sides 1025,1035 proximate the lower end 1042.

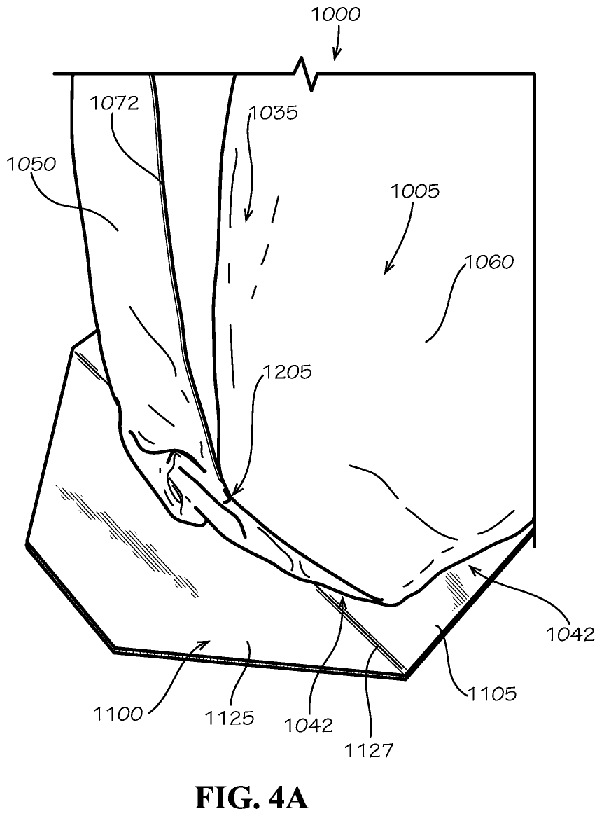

As seen with reference to FIGS. 4A-4B, proximate the lower end 1042 of the body portion 1005 and abutting with the support 1100 can be a pleat 1205 or a gathering of material. In the current aspect, the pleat 1205 can be simply an overlap of material from the joint along the seam 1072 between the front half 1050 and the rear half 1060. In various aspects, the pleat 1205 can be crumpled, folded, or otherwise mechanically arranged to create a region of excess material along a lower end 1042 of the body portion 1005 proximate the sides 1025,1035. Because of the location of the pleat 1205, the excess material can serve as a spring to the end portions 1115,1125 such that the end portions 1115,1125 can be biased to rotate outwardly along bend lines 1117,1127. Such spring force can be minimal, as it can be based entirely on the shape memory of the liner 1000; however, such spring force can be beneficial in helping secure the liner 1000 snugly within packaging while still allowing a user to assemble the liner 1000 within the packaging with minimal effort. Additionally, the arrangement of the pleats 1205 can be beneficial in providing said spring force with minimal additional materials, which itself can aid in recyclability of the liner 1000 as a whole and which can aid in ease of manufacturability, since the materials utilized to produce the liner 1000 can be minimal. In various aspects, the liner 1000 itself can be greater than 85% repulpable. In various aspects, the liner 1000 can be at least 80% repulpable.

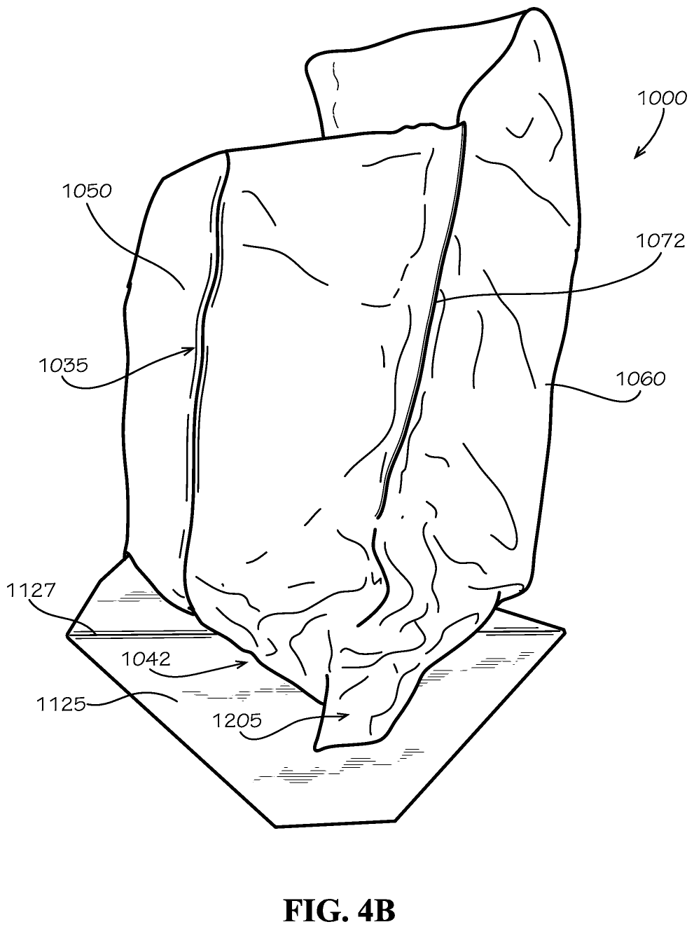

Assembly of the liner 1000 into a packaging assembly can be seen beginning with reference to FIG. 5. A box 1500 can be seen arranged proximate to the liner 1000. To begin insertion of the liner 1000 within the box 1500 to form the packaging assembly, the end portions 1115,1125 (1115 not seen in the current view) are folded along the bend lines 1117,1127, respectively, and the support 1100 can be arranged proximate a top end of the box 1500. When arranged, the central body 1105 of the support 1100 can be sized to fit within the box 1500 when the end portions 1115,1125 are folded along the bend lines 1117,1127. In the arrangement of FIG. 5, the pleats 1205 (not visible in the current view) can provide spring force against the end portions 1115,1125 to force the end portions 1115,1125 into contact with the box 1500. However, the weight of the liner 1000 can overcome the spring force and allow the liner 1000 to fall within the box 1500 in various aspects. In various aspects, the liner 1000 can be required to be manually inserted by a user, who can be required to push the liner 1000 into the box 1500 using human force. As previously noted, the taper defined by the tapered ends 1119a,b,1129a,b, can be beneficial in reducing resistance when assembling the liner 1000 into the box 1500 or other packaging.

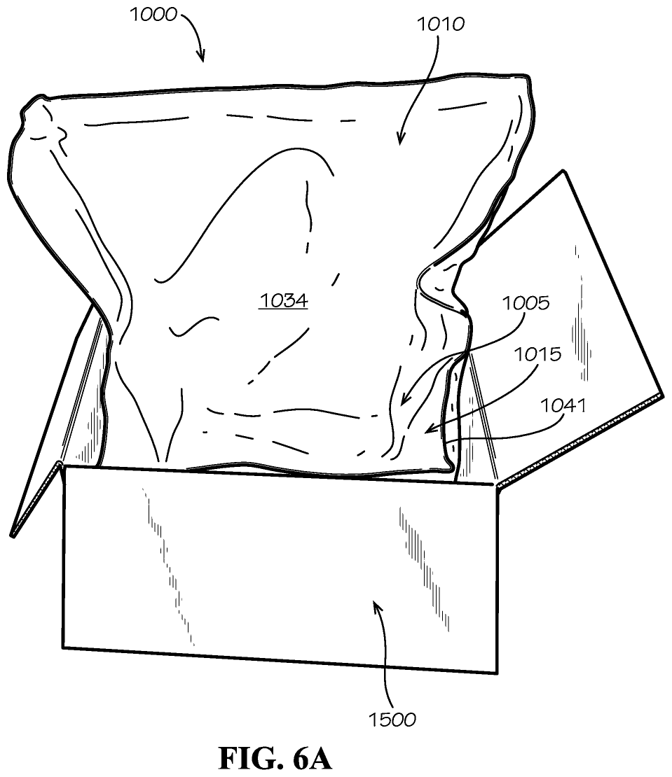

As seen with reference to FIGS. 6A-6B, the liner 1000 can be arranged to fit snugly within the box 1500. As can be seen, benefits of the kraft paper and insulation construction can allow the liner 1000 to substantially maintain its general shape while still being malleable within the box 1500 to fill an inside of the box 1500 substantially while maintaining a shape of the cavity 1015. As a result, the liner 1000 can substantially insulate materials inserted within it while being a simple construction that is easy to form into a packaging assembly. As can be seen, the liner 1000 can be sized such that the upper end 1041 can be located substantially close to an upper end of the box 1500, as such an arrangement can provide heightened insulative value. As seen with reference to FIG. 7, the liner 1000 can be fully packaged by folding the flap portion 1010 down over the cavity 1015 such that the flap portion 1010 at least partially contacts the upper end 1041. The flap portion 1010 can be connected to the upper end 1041 of the body portion 1005 utilizing various adhesives, mechanical fasteners, or various other joints as known in the art. In various aspects, the flap portion 1010 can be folded over the body portion 1005 without connecting.

A finalized packaging assembly can be generated by fully assembling the box 1500 into completed form. Various shapes, sizes, and arrangements of box 1500 can be utilized without departing from the scope of the current disclosure.

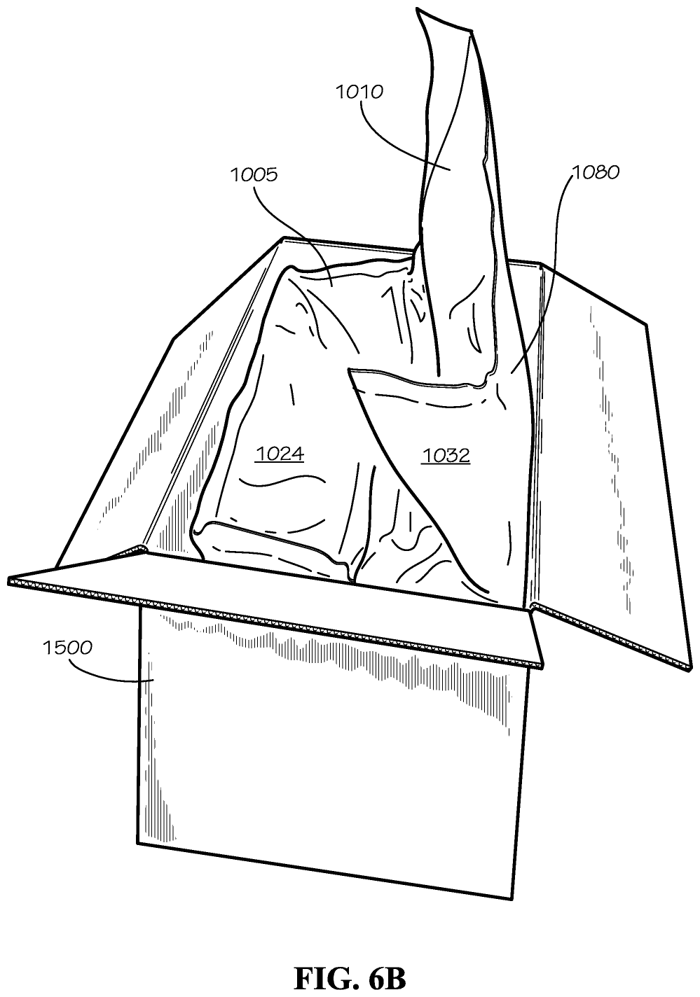

Another aspect can be seen with reference to FIG. 8. As can be seen, an insulative batt 2010 can be captured between an inner panel 2075 and an outer panel 2070. The insulative batt 2010 can be generally flexible in nature and can be capable of being bent or formed in various shapes. In various aspects, loose fill insulation can be utilized in place of the batt 2010. The panels 2070,2075 can be kraft paper or like materials as discussed elsewhere within this disclosure. The batt 2010 can be sized with slightly smaller dimensions than the inner panel 2075 and the outer panel 2070 such that the batt 2010 can be captured between the inner panel 2075 and the outer panel 2070 forming a single-piece panel assembly. The outer panel 2070 can include a perimeter sealing edge 2072 to interface with a perimeter sealing edge (not shown) of the inner panel 2075.

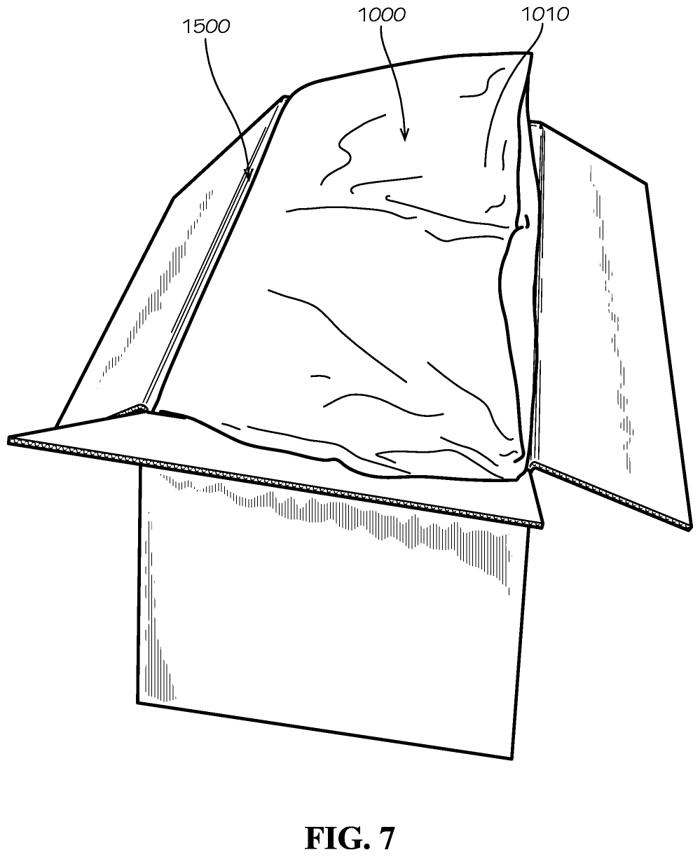

A liner panel assembly 2150 can be seen with reference to FIG. 9. The inner panel 2075 can be seen as adhered to the outer panel 2070, which cannot be seen. An outline 2011 of the batt 2010 can be seen for reference of the batt 2010 captured between the outer panel 2070 and the inner panel 2075. The liner panel assembly 2150 can comprise a plurality of sections. Lines are inserted for reference, and in various aspects the lines can be omitted or can be included.

A first panel section 2160 can comprise a lower end of the liner panel assembly 2150. A second panel section 2170 can comprise a central area of the liner panel assembly 2150. And a flap panel section 2180 can comprise a top end of the liner panel assembly 2150. The first panel section 2160 can be separated from the second panel section 2170 by a line 2161 and the second panel section 2170 can be separated from the flap panel section 2180 by a line 2171. In various aspects, the lines 2161,2171 can be reference lines drawn on the inner panel 2075. In various aspects, the lines 2161,2171 can be omitted entirely, and the lines 2161,2171 as drawn in FIG. 9 can be simple reference lines for illustration only. In various aspects, the lines 2161,2171 can represent score lines, bend lines, creases, perforations, or other weakened areas designed to assist in bending the liner panel assembly 2150 as desired.

In the current aspect, the first panel section 2160 can be of a height 2163 that is about the same as a height 2173 of the second panel section 2170. The first panel section 2160 can comprise a first sealing edge 2167 and a second sealing edge 2168. Similarly, the second panel section 2170 can comprise a first sealing edge 2177 and a second sealing edge 2178. The first sealing edges 2167,2177 can be adapted to abut and to seal against one another using various methods described elsewhere in this disclosure. Likewise, the second sealing edges 2168,2178 can be similarly adapted as the first sealing edges 2167,2177.

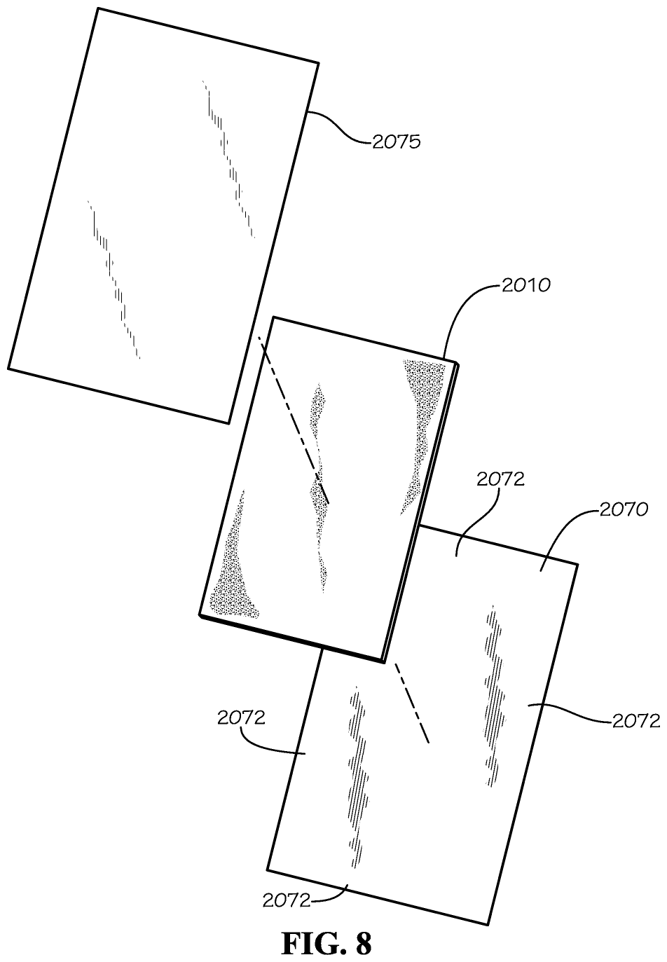

As seen with reference to FIG. 10, a liner subassembly 2250 can be formed from the liner panel assembly 2150 by adhering the first sealing edges 2167,2177 together and the second sealing edges 2168,2178 together. Once arranged as a liner subassembly 2250 similar to liner 1000, various features and arrangements of liner 1000 can be imported. For example, liner subassembly 2250 can comprise a body portion 2305 and a flap portion 2310. The liner subassembly 2250 can comprise a front 2320, sides 2325 and 2335, and a back 2330. Similar features of the liner 1000 not specifically articulated would be understood by one of skill in the art to be included with linear 2250.

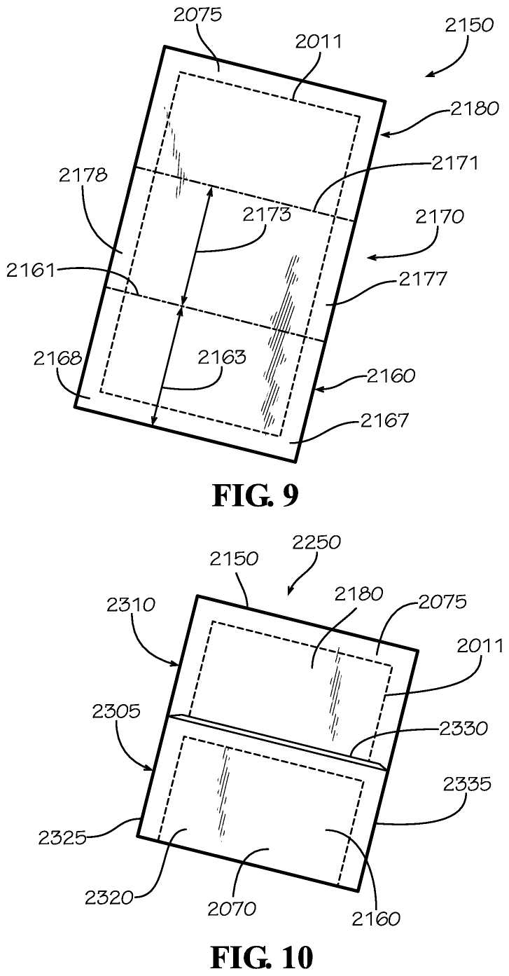

As seen with reference to FIG. 11, a support 2500 can comprise many substantially similar elements to support 1100. However, support 2500 can comprise a lengthwise bend line 2525 arranged linearly bisecting the support 2500 in a lateral direction. The lengthwise bend line 2525 can be arranged orthogonally to the bend lines 1117,1127. Because of the mechanical shape memory and inherent stiffness of the material, the support 2500 can be bent along lengthwise bend line 2525 or along at least one of bend lines 1117,1127. The lengthwise bend line 2525 can bisect the support 2500 into a first half 2524 and a second half 2526.

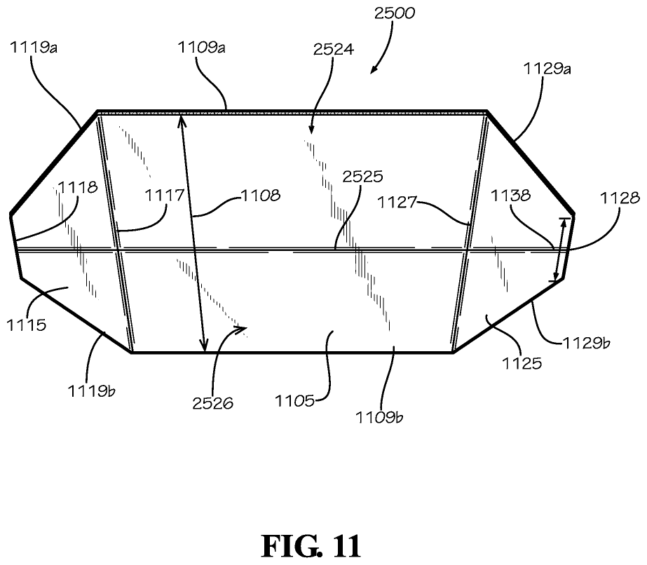

As seen with reference to FIG. 12, the liner subassembly 2250 can be arranged connected to or abutting the support 2500 using various connection mechanisms as disclosed elsewhere herein. In various aspects, the support 2500 can be adhered to the linear subassembly 2250 to form a liner 3000. The liner 3000 can be arranged in the laid-flat configuration of FIG. 12 for ease of shipping and storage. The liner 3000 can be shipped to customers or stored on shelves in the flattened arrangement more easily than in an expanded arrangement. The construction of the liner 3000 being of a single piece of insulative batt and of simple materials and assembly can produce very low costs of assembly and construction as compared to similar liner options that are construction of more pieces. The first half 2524 can be adhered to the front 1020 of the liner subassembly 2250 and the second half 2526 can be adhered to the back 1030 of the liner subassembly 2250.

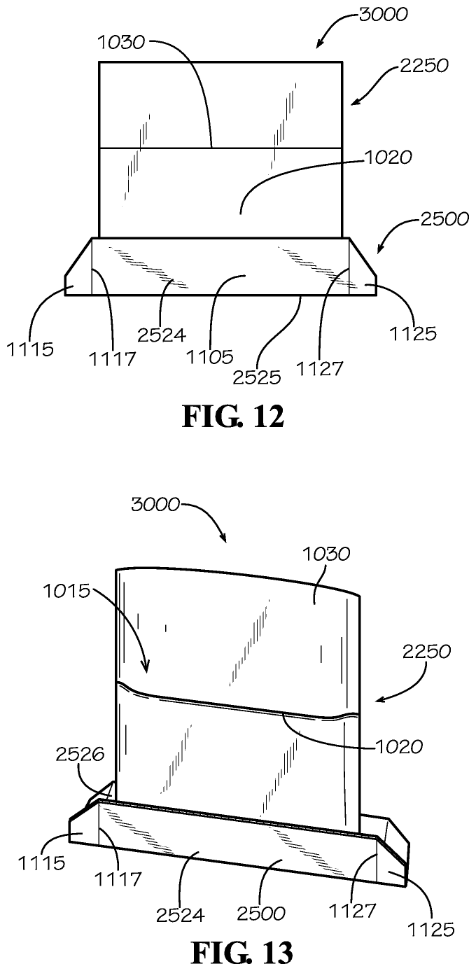

As can be seen with reference to FIG. 13, the support 2500 can begin to be hinged along the bend lines 1117,1127 to begin to open the support 2500 from its flattened position to a support position. When the support 2500 is adhered to the liner subassembly 2250, the front 1020 can follow the first half 2524 of the support 2500 and the back 1030 can follow the second half 2526. As such, the cavity 1015 can begin to be defined between the front 1020 and the back 1030.

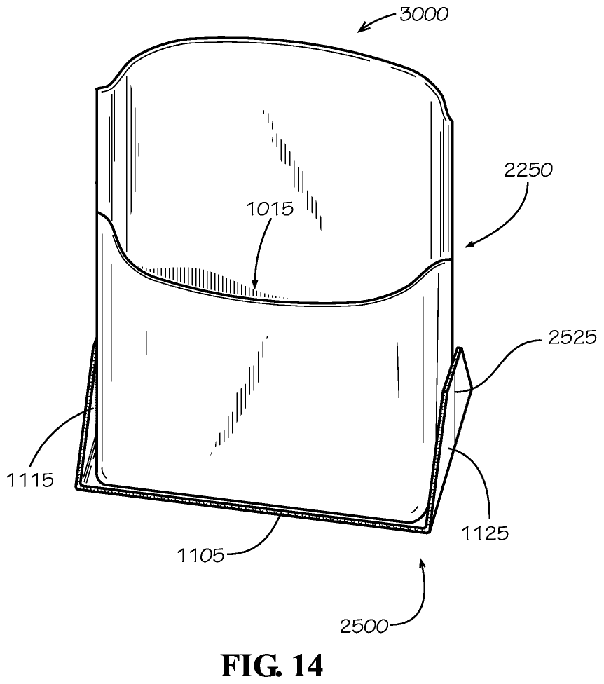

As seen with reference to FIG. 14, when the end portions 1115,1125 can be aligned about orthogonal to the central body 1105, the first half 2524 and the second half 2526 can be forced to open and lay flat such that the support 2500 can hold the liner subassembly 2250 open, keeping the cavity 1015 defined. In such an arrangement, the support 2500 can include little or no bending along the lengthwise bend line 2525. As such, the stiffness of the support 2500 can help define the shape of the liner 3000.

As seen elsewhere in this disclosure, the liner 3000 can be inserted into a box such as box 1500. When inserted within the box 1500, the end portions 1115, 1125 can be arranged such that the box 1500 can prevent the unbending along bend lines 1117,1127, respectively. As such, bending along lengthwise bend line 2525 can be prevented, and the liner 3000 can be maintained in an opened relationship, allowing for ease of use in packaging items within the box 1500 and liner 3000.

It would be noted by one of ordinary skill in the art that, although the end portions 1115,1125 of the current disclosure are seen bent upwards, it would be equally possible to bend these end portions 1115,1125 downward to achieve a similar result of preventing bending along lengthwise bend line 2525. Additionally, there may be advantages of bending downward that are not specifically discussed herein.

It would be understood by one of skill in the art that various aspects and features can be utilized within various other aspects and features of the disclosure, and one should not consider the disclosure limited by the scope of one particularly disclosed element.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A packaging assembly comprising:
a box; and
a liner positioned in the box, the liner comprising:
a panel comprising a fiber-based material; and
a single piece of insulative material coupled to the panel, the liner defining a plurality of sub-portions, the liner defining a plurality of bend lines, each bend line connecting one sub-portion of the liner with another sub-portion of the liner, and the single piece of insulative material and the panel together extending across at least two bend lines.

2. The packaging assembly of claim 1, wherein the liner comprises a second panel, the single piece of insulative material is captured between the panel and the second panel.

3. The packaging assembly of claim 2, wherein the second panel comprises a paper-based material.

4. The packaging assembly of claim 2, wherein the panel is adhered to the second panel.

5. The packaging assembly of claim 1, wherein the plurality of sub-portions of the liner comprises a flap, a back and a bottom.

6. The packaging assembly of claim 5, wherein the box defining a front, a back, a first side, a second side and a bottom, the back of the liner is adjacent to one of the front, the back, the first side or the second side of the box and the bottom of the of the liner is adjacent to the bottom of the box.

7. The packaging assembly of claim 1, wherein the plurality of sub-portions of the liner comprises a front, a first side and a second side.

8. The packaging assembly of claim 7, wherein the plurality of sub-portions of the liner further comprises a back.

9. The packaging assembly of claim 1, wherein the single piece of insulative material and the panel together extend across at least three bend lines.

10. The packaging assembly of claim 1, further comprising a support comprising a corrugated cardboard material, the support is situated within the box.

11. The packaging assembly of claim 10, wherein the box defining a front, a back, a first side, a second side and a bottom, the support is situated between the liner and the bottom of the box.

12. The packaging assembly of claim 1, wherein the fiber-based material is a paper-based material.

13. The packaging assembly of claim 1, wherein the insulative material comprises a paper-based material.

14. The packaging assembly of claim 1, wherein the liner is recyclable.

15. A packaging assembly comprising:
a box defining a front, a back, a first side, a second side and a bottom; and
a liner comprising:
a panel comprising a fiber-based material; and
a single piece of insulative material coupled to the panel, the liner defining a plurality of sub-portions, the plurality of sub-portions comprising a first sub-portion and a second sub-portion, the first sub-portion of the liner positioned adjacent to one of the front, the back, the first side or the second side of the box, the second sub-portion of the liner positioned adjacent to one of the front, the back, the first side or the second side of the box, the liner defining a plurality of bend lines, each bend line connecting one of the sub-portions of the liner with another sub-portion of the liner, the single piece of insulative material and the panel together extending across at least one bend line that is a vertical bend line.

16. The packaging assembly of claim 15, wherein the liner comprises a second panel, and wherein the single piece of insulative material is captured between the panel and the second panel.

17. The packaging assembly of claim 15, wherein the single piece of insulative material and the panel together extend across at least two bend lines.

18. The packaging assembly of claim 15, wherein the single piece of insulative material and the panel together extend across at least three bend lines.

19. The packaging assembly of claim 15, further comprising a support comprising a corrugated cardboard material, the support is situated within the box.

20. The packaging assembly of claim 19, wherein the support is situated between the liner and the bottom of the box.

21. A packaging assembly comprising:
a box defining a front, a back, a first side, a second side and a bottom; and
a liner comprising
a panel comprising a fiber-based material; and
a single piece of insulative material coupled to the panel, the liner defining a liner flap and a liner back, the liner back positioned adjacent to one of the front, the back, the first side or the second side of the box, the single piece of insulative material and panel together extending across a bend line connecting the liner flap with the liner back.

22. The packaging assembly of claim 21, wherein the liner comprises a second panel, and wherein the single piece of insulative material is captured between the panel and the second panel.

23. The packaging assembly of claim 21, wherein the liner further defines a liner bottom, and wherein the liner bottom is adjacent to the bottom of the box.

24. The packaging assembly of claim 23, wherein the single piece of insulative material and the panel together extend across a second bend line connecting the liner back with the liner bottom.

25. The packaging assembly of claim 21, wherein the fiber-based material is a paper-based material.

26. A method of assembling a packaging assembly comprising the steps of:
providing a box defining a front, a back, a first side, a second side, and a bottom;
providing a liner comprising:
a panel comprising a fiber-based material; and
a single piece of insulative material coupled to the panel, the liner defining a liner flap and a liner back, the liner back positioned adjacent to one of the front, the back, the first side or the second side of the box, and the single piece of insulative material and the panel together extending across a bend line connecting the liner flap with the liner back;
inserting the liner back within the box so that the liner back is adjacent to one of the front, the back, the first side or the second side of the box; and
folding the liner flap relative to the liner back.

27. The method of assembling the packaging assembly of claim 26, wherein the fiber-based material is a paper-based material.

28. The method of assembling the packaging assembly of claim 26, wherein the liner comprises a second panel, and wherein the single piece of insulative material is captured between the panel and the second panel.

29. The method of assembling the packaging assembly of claim 26, wherein the liner further defines a liner bottom, and wherein the single piece of insulative material and the panel together extend across a second bend line connecting the liner bottom with the liner back.

30. The method of assembling the packaging assembly of claim 29, wherein the method further comprises the step of folding the liner bottom relative to the liner back, and wherein the step of inserting the liner back within the box includes inserting the liner bottom within the box so that the liner bottom is adjacent to the bottom of the box.
